(19) United States
(12) Patent Application Publication
(10) Pub. No.: US 2005/0149992 A1
(43) Pub. Date: Jul. 7, 2005

(54) Media center based multiple player game mode

(76) Inventor: Louis A. Lippincott, Chandler, AZ (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/750,035

(22) Filed: Dec. 30, 2003

(51) Int. Cl. H04N 7/173; H04N 7/16

(52) U.S. Cl. 725/149

(57) ABSTRACT

A computer system runs an interactive multiplayer game program. The computer system includes a graphics subsystem including a number of graphics frame buffers. Each of these frame buffers is associated with a player, and each frame buffer stores images for the viewing perspective of the associated player. The images for the associated players may be output to separate viewing devices (computer monitor, television, etc.). The players are thus provided interactivity with each other and each player may view the game from his or hers own perspective.

### FIELD OF THE INVENTION

The present invention pertains to the field of computer systems. More particularly, this invention pertains to the field of media center based multiple player game modes.

### BACKGROUND OF THE INVENTION

Today's computer systems are being employed in a number of ways around the home and at the office. Computer gaming has become hugely popular. Interactive, multiplayer games have become especially popular. With multiplayer games, players typically share a split monitor (either a computer monitor or a television) or engage in game playing over the internet. With computer systems becoming more integrated with various media functions in the home, it would be desirable to have a way to allow multiplayer gaming using multiple displays (televisions, for example) within the home.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 is a block diagram of a computer system including components allowing for multiple player gaming using a number of displays.

FIG. 2 is a flow diagram of one embodiment of a method for allowing for multiple player gaming using a number of displays.

### DETAILED DESCRIPTION

In general, one embodiment involves a computer system running an interactive multiplayer game program. The computer system includes a graphics subsystem including a number of graphics frame buffers. Each of these frame buffers is associated with a player, and each frame buffer stores images for the viewing perspective of the associated player. The images for the associated players may be output to separate viewing devices (computer monitor, television, etc.). The players are thus provided interactivity with each other and each player may view the game from his or hers own perspective.

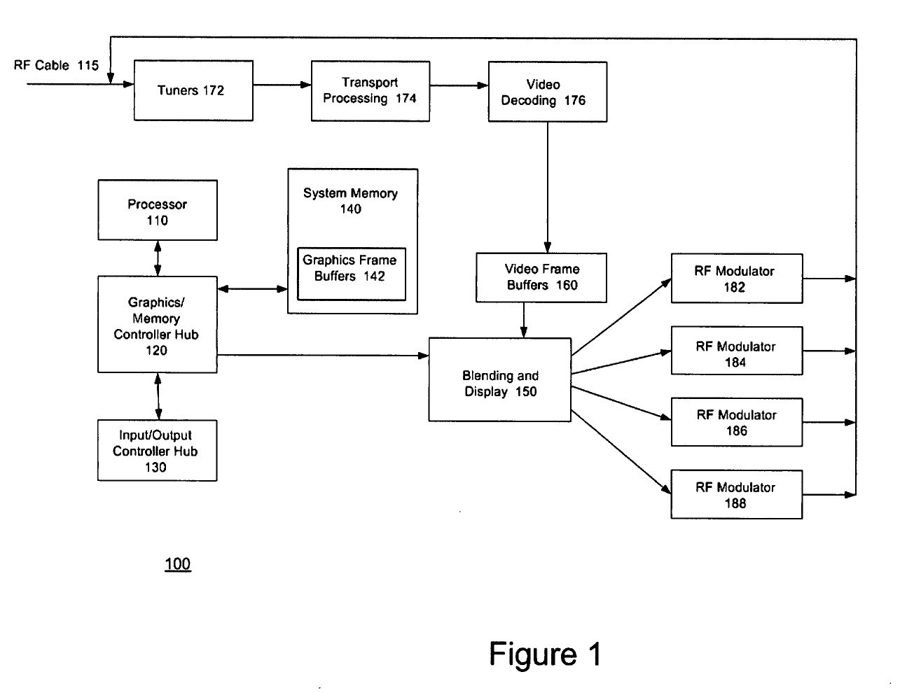

FIG. 1 is a block diagram of an example computer system 100 that includes components allowing for multiple player gaming using a number of displays. The system 100 includes a processor 110. The processor may be an Intel® processor, but other embodiments may include other brands or types of processors. The processor 110 is coupled to a graphics/memory controller hub 120. The hub 120 includes a memory controller that provides communication with a system memory 140. The hub 120 also includes, for this embodiment, a graphics controller. For this embodiment, a portion of the system memory 140 is used for graphics memory. Other embodiments may include a graphics controller that is not integrated into a hub. Other embodiments may also include graphics memory that is not a part of the system memory.

The graphics/memory controller hub 120 is also coupled to an input/output controller hub 130. The input/output hub 130 provides communication between various peripheral devices (not shown) and the remainder of the system. The various peripheral devices may include disk drives, keyboards, pointing devices, printers, etc.

For this embodiment, the graphics memory portion of the system memory 140 includes a number of graphics frame buffers 142. For this example embodiment, the number of graphics frame buffers 142 is four. Other embodiments are possible using other numbers of frame buffers. The number of graphics frame buffers represents the upper limit of the number of game players that would be able to view the game from the player's own perspective. So, for this embodiment, the maximum number of players is four.

The processor 110 may run an interactive game program that allows multiple players. Images for the various players are rendered by the graphics controller, which, for this example embodiment, resides in the graphics/memory controller hub 120. The images are stored in the graphics frame buffers 142. Each of the graphics frame buffers 142 is associated with a particular player, and the graphics frame buffers 142 contain the images for the viewing perspective of the associated players.

The images are delivered to a blending and display unit 150. The blending and display unit 150 routes the images to an appropriate display device. In this example embodiment, the blending and display unit 150 is coupled to RF modulators 182, 184, 186, and 188. “RF” denotes “radio frequency.” Each of the RF modulators 182, 184, 186 and 188 are coupled to an RF cable 115. The RF cable 115 may be coupled to a number of televisions within a home. The RF modulators 182, 184, 186, and 188 prepare the images received from the blending and display unit 150 for transmission over the RF cable 115. Each of the RF modulators may transmit signals using different cable channels. Therefore, each of the televisions coupled to the cable 115 can access the output of any of the RF modulators 182, 184, 186, and 188 by tuning to the appropriate channels.

The system 100 may also include a set of tuners 172 that receive input from the RF cable 115. The RF cable 115 may transmit television signals originating outside of the system 100 (e.g., from an antennae or cable television transmission line originating outside of the home) to the tuners 172. For this example embodiment, there number of tuners 172 is four, although other embodiments are possible using other numbers of tuners. Each of the tuners may be tuned to a separate cable channel in order to access signals originating outside of the system 100 or to access one the signals transmitted by the RF modulators 182, 184, 186, and 188.

The tuners 172 may deliver its output to a transport processing unit 174, which may in turn delivers the signals to a video decoding unit 176. The decoded video images are stored in video frame buffers 160. The number of video frame buffers for this example embodiment is four, although other embodiments are possible using other numbers of video frame buffers. The video frame buffers 160 deliver video image information to the blending and display unit 150 which blends the video and graphics information when appropriate before delivering the blended image information to the RF modulators 182, 184, 186, and 188.

Game playing typically involves the use of game controllers. Game controllers provide a way for the game players to control various aspects of the game. Among the ways that game controller information can be delivered to the system 100 include sending the information over the RF cable. Another way to deliver game controller information to the system 100 is via wireless communication. In one embodiment, the game controller information is received at the input/output controller hub 130. The game program being executed by the processor 110 can use the game controller information to help dictate game action.

Although the embodiments described herein discuss using an RF cable to connect televisions throughout a home, other embodiments are possible using other techniques for delivering image information to viewing devices. Further, the viewing devices are not limited to televisions, but may include computer monitors or any other viewing device. Therefore, other embodiments may replace the RF modulators 182, 184, 186, and 188 with other devices suitable for the chosen transmission medium. Also, although the embodiments described herein discuss using the system 100 within a home, the system 100 may be used at any location (home, office, clubhouse, etc.).

For the embodiments described herein, the tuners 172, the transport processing unit 174, the video decoding unit 176, the video frame buffers 160, the blending and display unit 150, and the RF modulators 182, 184, 186, and 188 are shown as discrete devices separate from the graphics/memory controller hub 120. Other embodiments are possible where some or all of these units are integrated within a graphics/memory controller hub or within other devices. The above mentioned units may also be integrated into one or more devices.

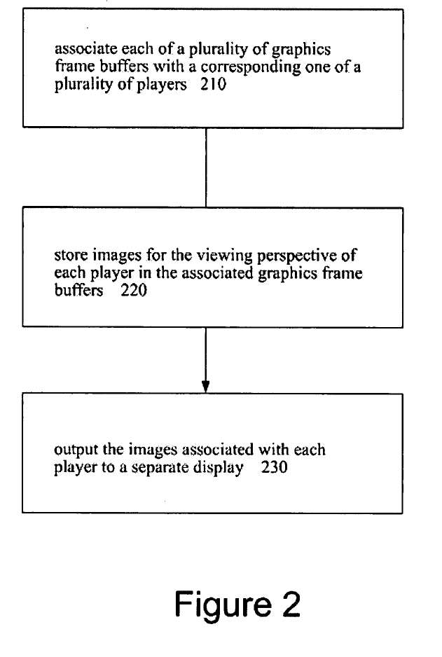

FIG. 2 is a flow diagram of one embodiment of a method for allowing for multiple player gaming using a number of displays. At block 210, each of a plurality of graphics frame buffers is associated with a corresponding one of a plurality of players. At block 220, images are stored for the viewing perspective of each player in the associated graphics frame buffers. Then, at block 230, the images associated with each player are output to separate displays. This example embodiment of a method may be practiced using a system such as that described above in connection with FIG. 1.

In the foregoing specification the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than in a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

1. An system, comprising:
a processor;
a memory controller hub coupled to the processor;
a plurality of graphics frame buffers coupled to the memory controller hub;
a plurality of video frame buffers, the video frame buffer to receive input from a plurality of tuners;
a blending and display unit to receive input from the plurality of video frame buffers and the memory controller hub; and
a plurality of video output units coupled to the blending and display unit.

2. The system of claim 1, the plurality of tuners to receive input from an RF cable.

3. The system of claim 2, the plurality of video output units to each include an RF modulator.

4. The system of claim 3, each of the plurality of video output units to output a video display signal onto the RF cable.

5. The system of claim 4, wherein each of the plurality of video output units outputs a video display signal onto separate channels on the RF cable.

6. The system of claim 5, wherein the RF cable is coupled to a plurality of televisions.

7. The system of claim 6, further comprising a plurality of game controllers couple to an input/output hub controller, the input/output hub controller coupled to the graphics/memory controller hub.

8. The system of claim 7, wherein at least one of the plurality of game controllers is coupled to the input/output controller hub via the RF cable.

9. The system of claim 7, wherein at least one the plurality of game controllers is coupled to the input/output controller hub via a wireless connection.

10. A method, comprising:
associating each of a plurality of graphics frame buffers with a corresponding one of a plurality of players,
storing images for the viewing perspective of each player in the associated graphics frame buffers; and
outputting the images associated with each player to a separate display.

11. The method of claim 10, further comprising blending graphics frames with video frames before outputting the images.

12. The method of claim 11, further comprising receiving an input from an RF cable at a plurality of tuners.

13. The method of claim 12, wherein outputting the images associated with each player to a separate display includes outputting the images to a plurality of televisions.

14. The method of claim 13, further comprising receiving game controller input, the game controller input causing modification of the viewing perspective of at least one of the plurality of players.

15. The method of claim 14, wherein receiving game controller input includes receiving the game controller input via a wireless connection.

16. The method of claim 14, wherein receiving game controller input includes receiving the game controller input via the RF cable.
